(19) United States
(12) Patent Application Publication
(10) Pub. No.: US 2010/0117473 A1
(43) Pub. Date: May 13, 2010

(54) ROBUST PERMANENT MAGNET ROTOR ASSEMBLY

(76) Inventors: Mike M. Masoudipour, Torrance, CA (US); Davis Jensen, Torrance, CA (US)

Correspondence Address: HONEYWELL/SHIMOKAJI;PATENT SERVICES, 101 Columbia Road, P.O.Box 2245, Morristown, NJ, 07962-2245, US

(21) Appl. No.: 12/269,607

(22) Filed: Nov. 12, 2008

(51) Int. Cl. H02K 21/14

(52) U.S. Cl. 310/156.28

(57) ABSTRACT

A rotor assembly for an electric motor having at least one gas vent allowing for the release of gases from within an enclosed portion is provided. The rotor assembly comprises a rotor shaft with at least one magnet longitudinally extending a portion of an outer surface thereof in an axial direction and being retained therewith. A non-magnetic wedge spacer may be positioned between each of a plurality of magnets and a cylindrical sleeve may be positioned about the at least one magnet. An end cap or stub shaft is adhered or mechanically held to or within each end of the cylindrical sleeve adjacent the at least one magnet forming an enclosed portion of the rotor assembly. At least one vent hole, channel, or bevel provides a gas flow through passage in flow communication with the enclosed portion and an environment outside of the enclosed portion of the rotor assembly.

### BACKGROUND OF THE INVENTION

The present invention relates generally to permanent magnet rotor assemblies for electric motors, and more specifically to a more robust rotor assembly that provides for release of gases from an enclosed portion thereof thus reducing pressure in the enclosed portion of the rotor assembly.

Permanent magnet rotors for electric motors typically comprise a rotor assembly having a rotor iron shaft with a plurality of magnets adhered to an outer surface thereof. The magnets may have an arcuate cross-sectional configuration with a longitudinal axis extending a portion of the outer surface of the rotor shaft and retained thereto with an adhesive. The rotor may be constructed with a single magnet. This magnet may also be cylindrical in cross-section, with or without a cylindrical aperture through the center. This cylindrical magnet may be an assembly of a plurality of pieces, retained together by an adhesive. The magnets are typically permanent magnets and may be rare-earth or ceramic magnets. The magnets may be adhered to the shaft with an adhesive. A non-magnetic cylindrical sleeve may then be positioned about the magnets and may be retained to outer surfaces thereof with an adhesive to inhibit longitudinal movement of the magnets about the shaft. A disk shaped end cap may then be placed within or on each end of the cylindrical sleeve. The end caps may have a central aperture about an outer circumference of the shaft adjacent the plurality of arcuate magnets and have an inner surface adhesively retained to longitudinal ends of the cylindrical magnets or the plurality of arcuate magnets. The end caps may also be adhesively or mechanically retained within the cylindrical sleeve. The end caps may aid in maintaining alignment of the magnets and balance of the rotor assembly.

These typical rotor assemblies have adhesives about portions of the shaft, magnets, sleeve, and end caps. During construction and use, the rotor assembly may be subject to heat. The heat may cause gases to evolve from the adhesive which may become trapped within portions of the rotor assembly. These gases may exert pressure forcing components of the assembly apart, weakening the rotor assembly. For example, end caps of the rotor may become displaced, which may cause misalignment and unbalance of the rotor assembly and may lead to catastrophic failure of the electric motor.

As can be seen, there is a need for a more robust rotor assembly for an electric motor.

### SUMMARY OF THE INVENTION

According to one aspect of the present invention, a rotor assembly for an electric motor is provided having a rotor shaft, a plurality of magnets longitudinally extending a portion of an outer surface of the rotor shaft and being retained thereto with an adhesive, a cylindrical sleeve positioned about the plurality of magnets, and a disk shaped end cap adhesively or mechanically retained adjacent each end of the cylindrical sleeve. Each end cap has a central aperture about an outer circumference of the shaft adjacent the plurality of magnets and has a surface adhesively or mechanically retained adjacent longitudinal ends of the cylindrical sleeve. At least one hole, channel, or bevel is in at least one of the rotor shaft, cylindrical sleeve, non-magnetic wedge spacers, or end caps providing a gas flow through passage in flow communication with the enclosed portion and an environment outside of the enclosed portion thereof.

In another aspect of the present invention, end caps are provided for a rotor assembly having a disk with an inside face, an outside face, and a round central aperture suitable for closely receiving a portion of a rotor shaft. At least one vent hole extends from an outer edge of the inside face of the disk to the outside face of the disk and from an inner edge adjacent the central aperture of the inside face to the outside face.

In yet another aspect of the present invention, a rotor assembly is provided having a shaft with a plurality of longitudinally extending magnets adhesively retained to an outer surface thereof. Wedge shaped non-magnetic spacers are between each of the magnets. A rotor sleeve closely receives the magnets and spacers. An end cap having a central aperture closely receives a rotor shaft and is adhesively held within or to each end of the rotor sleeve forming an enclosure about the magnets. At least one gas vent for venting gases evolved from heating adhesives to an environment outside of the enclosure is provided.

These and other features, aspects and advantages of the present invention will become better understood with reference to the following drawings, description and claims.

### BRIEF DESCRIPTION OF THE DRAWINGS

FIG. 1 is a perspective view of a rotor assembly for an electric motor according to the present invention;

FIG. 2 is a cross-sectional view of the rotor assembly of FIG. 1;

FIG. 3 is an exploded view of the rotor assembly of FIG. 1;

FIG. 4A is front view of an aspect of an end cap of the present invention having groves; FIG. 4B is a cross-sectional view of an end cap of the present invention shown in FIGS. 1-3;

FIG. 5 is an axial cross-sectional view of a rotor assembly of an aspect of the present invention;

FIG. 6A is a cross-sectional view of a stub shaft having venting holes;

FIG. 6B is a side view of a stub shaft having venting grooves;

FIG. 7A is a perspective view of a two pole magnet having a central venting hole;

FIG. 7B is a perspective view of a two pole magnet having a solid core

FIG. 8A is a cross-sectional view of a rotor assembly having a central venting hole; and

FIG. 8B is a cross-sectional view of a rotor assembly having a solid central core.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The configuration of the rotor assembly for an electric motor of aspects of the present invention provides at least one means for venting gases from an enclosed portion thereof. The rotor assembly may be formed by adhering longitudinal extending magnets with or without a non-magnetic spacer therebetween, axially about a circumferential portion of the rotor with an adhesive. Alternatively, a two pole magnet may be used to make up the rotor where the rotor comprises a plurality of magnets adhesively bonded together. An outer sleeve may then be placed about an outer surface of the rotor and is optionally held to an outer surface thereof with an adhesive. End caps or stub shafts may be adhesively or mechanically retained to or within the ends of the outer sleeve and optionally adhesively held to longitudinal ends of the magnent(s) or magnets and spacers. The end caps may have a central aperture for closely receiving a rotor. The outer sleeve and end caps or stub shafts form an enclosed portion of the rotor assembly. During production or use, the rotor assembly may become heated and gases may be generated from the volatilization of a portion of the adhesives securing the component parts together. In the prior art, these evolved gases may become trapped within the enclosed portion of the rotor assembly. These trapped gases may exert pressure forcing components of the assembly apart, weakening the rotor assembly. For example, end caps or stub shafts of the rotor may become displaced, which may cause misalignment and unbalance of the rotor assembly and may lead to catastrophic failure of the electric motor. Aspects of the rotor assembly of the present invention provide at least one means for venting these trapped gases from the enclosed portion reducing the pressure within thus providing a more robust rotor assembly.

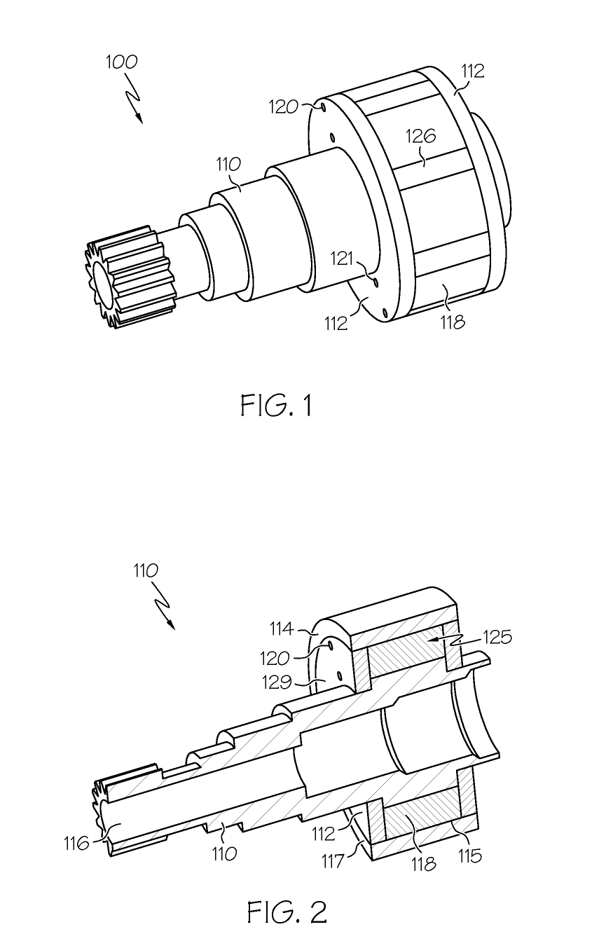

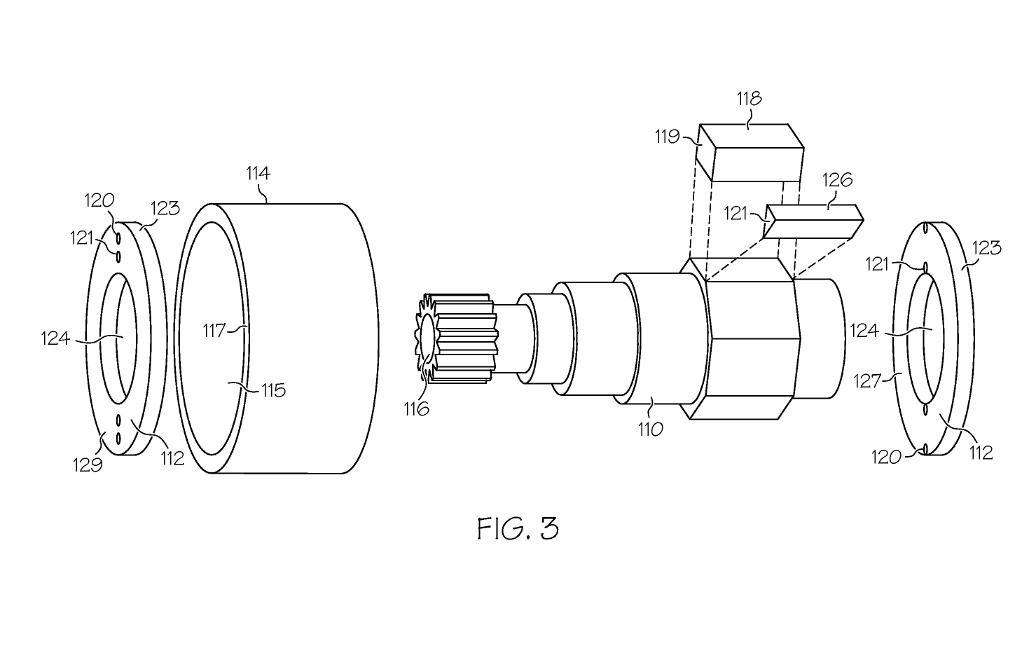

Referring to FIG. 1, there is shown rotor assembly 100 having cylindrical sleeve 114 (shown in FIG. 2) removed. This aspect of the present invention has rotor shaft 110 with a plurality of magnets 118 longitudinally extending a portion of an outer surface of rotor shaft 110 in an axial direction and being retained thereto with an adhesive. Magnets 118 may be bar shaped as shown in the figures or may have an arcuate cross-sectional configuration, or may have other configurations as are known in the art. Magnets 118 may be permanent magnets and may be rare-earth, ceramic, or have other composition as is known in the art. Non-magnetic wedge spacers 126 may be positioned between each magnet 118 and may be adhered to rotor shaft 110 and/or magnets 118 with an adhesive. End caps 112 are shown positioned about rotor shaft 110 adjacent ends of magnets 118 and wedge spacers 126. End caps 112 may have an inner surface 127 (shown in FIG. 3) adhesively retained to the ends of magnets 118 and wedge spacers 126. Alternatively, end caps 112 may be mechanically secured into position with a close fiting cylindrical sleeve 114.

FIG. 2 shows cylindrical sleeve 114 optionally positioned about magnets 118 and non-magnetic wedge spacers 126. Disk shaped end caps 112 may be adhered to an inner surface 115, to each end 117 of cylindrical sleeve 114, or mechanically retained within cylindrical sleeve 114. Advantageously, end caps with central aperture 124 (shown in FIG. 3) closely receive an outer circumferential surface of rotor shaft 110 adjacent longitudinal ends 119 (shown in FIG. 3) of magnets 118 and longitudinal ends 121 (shown in FIG. 3) of wedge spacers 126. End caps 112 may have an outer circumferential edge 123 (shown in FIG. 3) or inner surface 127 (shown in FIG. 3), or both, adhesively retained proximate ends 117 (shown in FIG. 3) of cylindrical sleeve 114, forming an enclosed portion 125 of rotor assembly 100. Optionally, end caps 112 may be adhered to longitudinal ends 119 of magnets 118 and/or longitudinal ends 121 of spacers 126 with an adhesive material. Alternatively or additionally, end caps 112 may have an outer edge 123 adhesively adhered to inner surface 115 of cylindrical sleeve 114 or have inner surface 127 adhered to ends 117 of cylindrical sleeve 114. End caps 112 may be mechanically secured within cylindrical sleeve 114 without adhesives forming an enclosed portion 125 of rotor assembly 100.

In FIG. 3 there is shown an exploded view of rotor assembly 100. Cylindrical sleeve 114 is shown removed from an outer portion of magnets 118 and wedge spacers 126. Magnets 118 and non-magnetic wedge spacers 126 are shown removed from each other and rotor shaft 110. End caps 112 are shown positioned about rotor shaft 110 adjacent ends of magnets 118 and wedge spacers 126. End caps 112 are shown removed from rotor shaft 110.

Cylindrical sleeve 114 may have ends 117 and inner surface 115. Rotor shaft 110 may have central hollow portion 116. Magnets 118 may have ends 119 and non-magnetic wedge spacers 126 may have ends 121. Disk shaped end caps 112 are shown removed from rotor shaft 110. End caps 112 may have central aperture 124, outer circumferential edge 123, and inner surface 127. End caps 112 may have at least one gas vent hole 120 which may be in flow communication with the enclosed portion 125 of rotor assembly 100 and the outside of enclosed portion 125. Gas vents 120 may provide rotor assembly 100 with a means for releasing gases generated from the heating of adhesives within enclosed portion 125.

In the aspect of the present invention shown in FIGS. 1-3, each end cap 112 may have at least one vent hole 120 extending from an inside face 127 adjacent the plurality of magnets 118 to an outside face 129 thereof. Additionally, this aspect of the invention may incorporate a solid rotor 110 as opposed to the rotor 110 having central hollow portion 116 as shown.

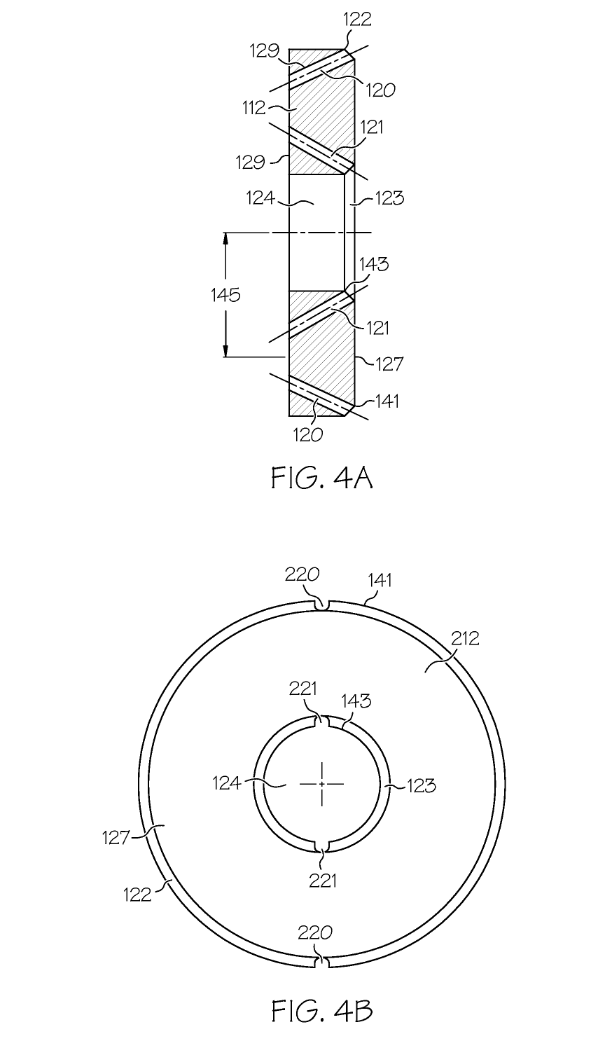

FIG. 4A shows a side cross-sectional view of an end cap 112 for rotor assembly 100 for an electric motor. End cap 112 may be disk shaped and may have an inside face 127, an outside face 129, and a round central aperture 124 suitable for closely receiving a portion of rotor shaft 110. Advantageously, end cap 112 may closely receive rotor shaft 110 such that a seal is formed therebetween forcing gases generated from the heating of adhesives within enclosed portion 125 through vent holes 120 and 121. A plurality of vent holes 120 may extend from an outer edge 141 of inside face 127 to outside face 129. A plurality of vent holes 121 may extend from an inner edge 143 adjacent central aperture 124 of inside face 127 to outside face 129. Advantageously, each vent hole 120 extending from the outer edge 141 of inside face 127 of disk or end cap 112 and each vent hole 121 extending from the inner edge 143 of inside face 127 may be radially aligned about disk 112. More advantageously, each vent hole 120 and 121 in disk 112 may be radially aligned thereabout so that disk 112 is substantially balanced about central aperture 124. This aspect of the present invention may help to provide for a balanced rotor assembly 100 which may reduce a wobbling tendency and be advantageous for use in high speed electric motors. Optionally, vent holes 120 and 121 may be angled from the inside edges 141 and 143 from which they extend on front face 127 toward a radius 145 between outer edge 141 and inner edge 143 on outside face 129.

In another aspect shown in FIG. 4A, outside edge 141 of inside face 127 of disk 112 has beveled edge 122. Additionally, the inside edge 143 of inside face 127 may have beveled edge 123. In the aspect shown here, both edges are beveled, however it is to be understood that only one or neither edge may have a bevel and be within the scope of the invention. Beveled edges 122 and 123 may provide a void space about inside edges of disk 112 which may provide for gas flow from the surface of rotor shaft 110 to which magnets 118 are adhered and from an inner surface of sleeve 114 to an environment outside of enclosed portion 125 of rotor assembly 100 through vent holes 120 and 121.

FIG. 4B shows a front face view of an end cap 212 for rotor assembly 100 for an electric motor. End cap 212 may be disk shaped and may have an inside face 127, an outside face 129, and a round central aperture 124 suitable for closely receiving a portion of rotor shaft 110. Advantageously, end cap 212 may closely receive rotor shaft 110 such that a seal is formed therebetween. A plurality of channels 220 may extend from an outer edge 141 of inside face 127 to outside face 129. A plurality of channels 221 may extend an inner edge 143 adjacent central aperture 124 of inside face 127 to outside face 129. Advantageously, channels 220 and 221 are axial aligned and form gas flow through channels from inner surface 127 to an environment outside of enclosed portion 125. Advantageously, each channel 220 extending from the outer edge 141 of inside face 127 of disk or end cap 212 and each channel 221 extending from the inner edge 143 of inside face 127 may be radially aligned about disk 212. More advantageously, each channel 220 and 221 in disk 112 may be radially aligned thereabout so that disk 212 is substantially balanced about central aperture 124. In another aspect shown in FIG. 4B, outside edge 141 of inside face 127 of disk 212 has beveled edge 122. Additionally, the inside edge 143 of inside face 127 may have beveled edge 123. In the aspect shown here, both edges are beveled, however it is to be understood that only one or neither edge may have a bevel and be within the scope of the invention. Beveled edges 122 and 123 may provide a void space about inside edges of disk 112 which may provide for gas flow from the surface of rotor shaft 110 to which magnets 118 are adhered and from an inner surface of sleeve 114 to an environment outside of enclosed portion 125 of rotor assembly 100 through channels 220 and 221.

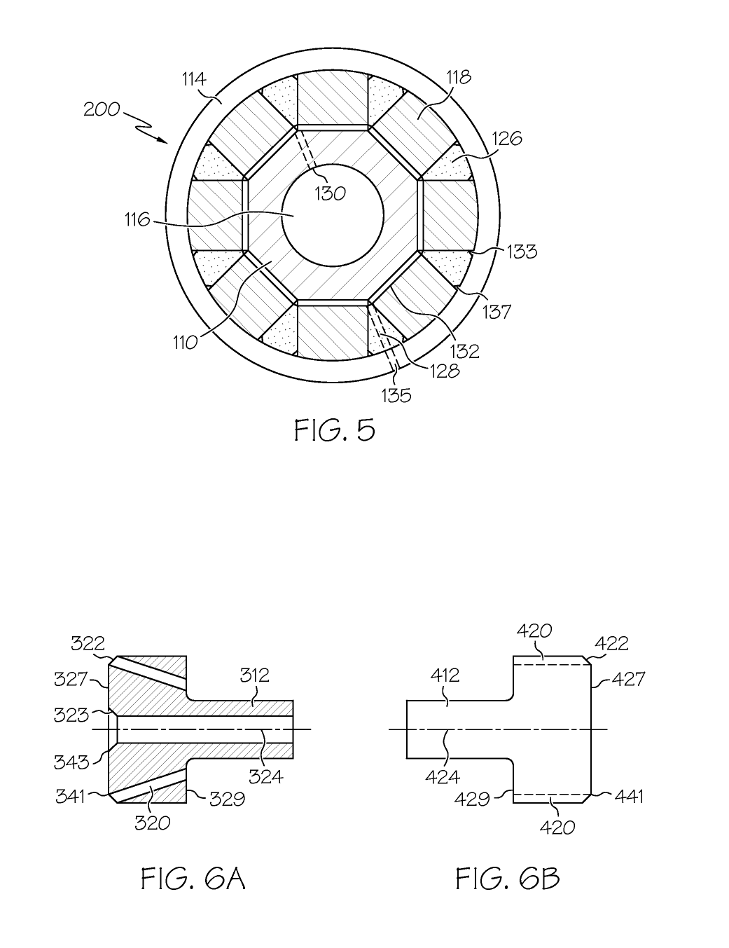

FIG. 5 shows a cross-section of rotor assembly 200 for an electric motor. Rotor assembly 200 may comprise shaft 110 with a plurality of longitudinally extending, axially aligned magnets 118 adhesively retained to an outer surface thereof. A wedge shaped non-magnetic spacer 126 may be positioned between each magnet 118. Rotor sleeve 114 may closely receive magnets 118 and spacers 126. Optionally, rotor sleeve 114 may be attached to an outer surface of magnets 118 and spacers 126 with an adhesive. An end cap 112 may be adhesively held to or within each end of rotor sleeve 114 and optionally to each end of magnets 118 and spacers 126. Each end cap 112 may have a central aperture closely receiving shaft 110 forming an enclosure about magnets 118 and spacers 126.

Several gas vents 128, 130, 135 and/or 137 may be provided with different aspects of the present invention. These gas vents may be incorporated into rotor assembly 200 individually or in conjunction with other gas vents such as gas vent holes 120 in end caps 112. FIG. 5 shows several gas vents or flow through passages 128, 130, 135, and 137 of aspects of the present invention incorporated into rotor assembly 200. It is to be understood that only one of such gas vents shown in the figures or as will become apparent to one skilled in the art upon reading this disclosure need be incorporated into a rotor assembly to be within the scope of the invention.

FIG. 6A shows a cross-sectional view of a stub shaft 312 for a rotor assembly for an electric motor. Stub shaft 312 may have an inside face 327, an outside face 329, and a round central aperture 324. A plurality of vent holes 320 may extend from an outer edge 341 of inside face 327 to outside face 329. Advantageously, each vent hole 320 in stub shaft 312 may be radially aligned thereabout so that stub shaft 312 is substantially balanced about central aperture 324. This aspect of the present invention may help to provide for a balanced rotor assembly. Optionally, outside edge 341 of inside face 327 of stub shaft 312 has beveled edge 322. Additionally, the inside edge 343 of inside face 327 may have beveled edge 323. In the aspect shown here, both edges are beveled, however it is to be understood that only one or neither edge may have a bevel and be within the scope of the invention. Beveled edges 322 and 323 may provide a void space about inside edges of stub shaft 312 which may provide for gas flow from the surface of a rotor shaft and/or from an inner surface of sleeve 114 to an environment outside of enclosed portion 125 of a rotor assembly.

FIG. 6B is a side view of a stub shaft 412 having venting grooves 420. Stub shaft 412 may be may have an inside face 427 and an outside face 429. A plurality of channels 420 may extend from an outer edge 441 of inside face 427 to outside face 429. Advantageously, channels 420 are axial aligned and form gas flow through channels from inner surface 427 to an environment outside of enclosed portion 125. More advantageously, each channel 420 in stub shaft 412 may be radially aligned thereabout so that stub shaft 412 is substantially balanced about a central axis 424. In another aspect, outside edge 441 of inside face 427 may have a beveled edge 422. Beveled edge 422 may provide a void space about an inside edge of stub shaft 412 which may provide for gas flow from the surface of a rotor shaft to which magnets may be adhered and/or from an inner surface of sleeve 114 to an environment outside of enclosed portion 125 of a rotor assembly through channels 420.

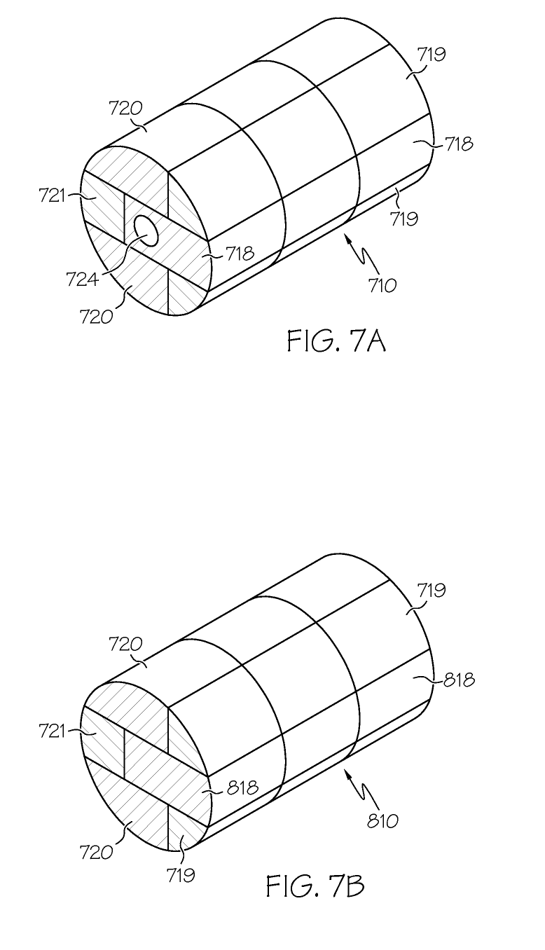

FIG. 7A shows rotor shaft 710 comprised of a two pole magnet having a central venting hole 724. Rotor shaft 710 is comprised of a plurality of magnets 718, 719, 720, and 721. Each magnet 718, 719, 720, and 721 has a configuration suitable for forming a cylindrical rotor shaft 710 when pieced together as shown in FIG. 7A. Each magnet 718, 719, 720, and 721 may be adhesively secured to adjacent magnets to form a two pole magnet. Rotor shaft 710 may have central vent hole 724 extending the central longitudinal axis thereof. Magnets 718 may have holes therein such that when axially aligned to form a portion of cylindrical rotor shaft 710, central vent hole 724 is formed therein. Central vent hole 724 may form a gas flow through passage in rotor shaft 710 suitable for venting gases generated by heating of adhesives securing magnets 718, 719, 720, and 721 together to an environment outside of enclosed portion 125.

FIG. 7B shows rotor shaft 810 comprised of a two pole magnet having a solid core. Rotor shaft 810 is comprised of a plurality of magnets 818, 719, 720, and 721. Each magnet 818, 719, 720, and 721 has a configuration suitable for forming a cylindrical rotor shaft 810 when pieced together as shown in FIG. 7B. Each magnet 818, 719, 720, and 721 may be adhesively secured to adjacent magnets to form a two pole magnet. Rotor shaft 810 may have a solid core.

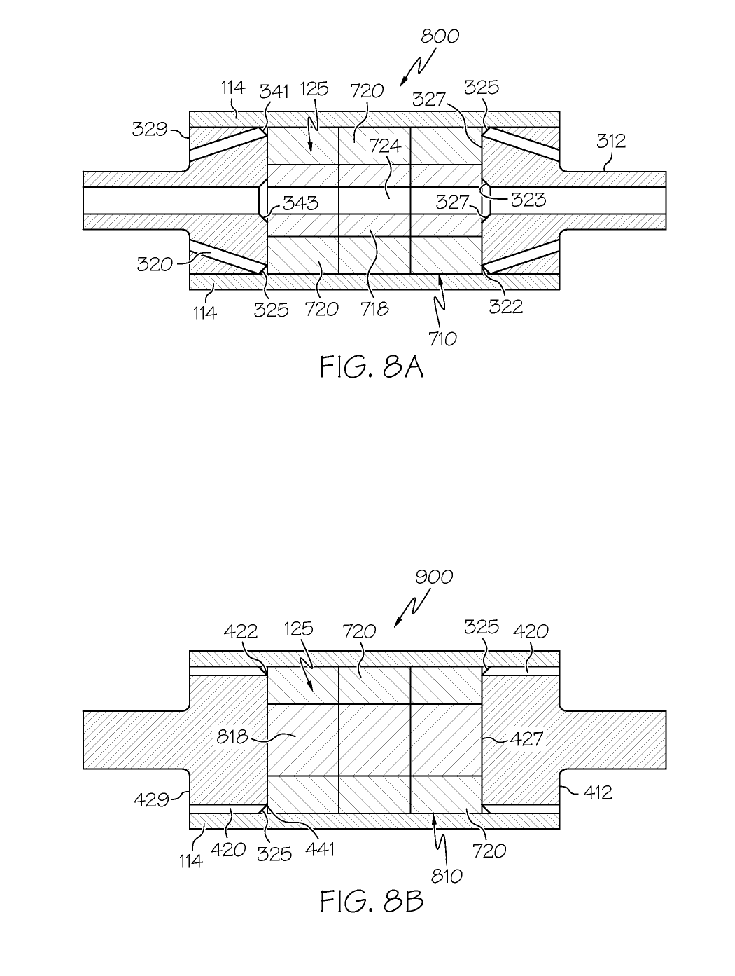

FIG. 8A shows a cross-sectional view of rotor assembly 800 having a stub shaft 312 on each end of rotor shaft 710. Stub shaft 312 may have an inside face 327, an outside face 329, and a round central aperture 324. A plurality of vent holes 320 may extend from an outer edge 341 of inside face 327 to outside face 329. Optionally, outside edge 341 of inside face 327 of stub shaft 312 has beveled edge 322. Additionally, the inside edge 343 of inside face 327 may have beveled edge 323. Beveled edges 322 and 323 may provide void spaces 325 and 327 about inside edges of stub shaft 312 which may provide for gas flow from the surface of rotor shaft 710 and/or from an inner surface of sleeve 114 to an environment outside of enclosed portion 125 of a rotor assembly. Rotor shaft 710 is a two pole magnet having a central venting hole 724 axially aligned with central aperture 324 in stub shaft 312 providing rotor assembly 800 with an axially extending central vent hole. Rotor shaft 710 is comprised of a plurality of magnets 718, 719, 720, and 721. Each magnet 718, 719, 720, and 721 may be adhesively secured to adjacent magnets to form a two pole magnet. Magnets 718 may have holes therein such that when axially aligned to form a portion of cylindrical rotor shaft 710, central vent hole 724 is formed therein. Central vent hole 724 may form a gas flow through passage in rotor shaft 710 suitable for venting gases generated by heating of adhesives securing magnets 718, 719, 720, and 721 together through central apertures 324 to an environment outside of enclosed portion 125.

FIG. 8B shows rotor assembly 900 having a solid central core. Stub shafts 412 extend from each axial end of rotor shaft 810 and may have an inside face 427 adjacent rotor shaft 810 and an outside face 429. A plurality of channels 420 may extend from an outer edge 441 of inside face 427 to outside face 429. Advantageously, channels 420 are axial aligned and form gas flow through channels from inner surface 427 to an environment outside of enclosed portion 125. Outside edge 441 of inside face 427 may have a beveled edge 422. Beveled edge 422 may provide a void space 325 about an inside edge of stub shaft 412 which may provide for gas flow from the surface of a rotor shaft to which magnets may be adhered and/or from an inner surface of sleeve 114 to an environment outside of enclosed portion 125 of a rotor assembly through channels 420. Rotor shaft 810 is comprised of a two pole magnet having a solid core. Rotor shaft 810 is comprised of a plurality of magnets 818, 719, 720, and 721. Each magnet 818, 719, 720, and 721 may be adhesively secured to adjacent magnets to form a two pole magnet. Rotor shaft 810 may have a solid core.

Shaft 110 may have a hollow interior 116 and bevels 132 adjacent each longitudinal end of each of magnet 118 and a vent hole 130 extending from bevel 132 to the hollow interior 116 thereof. Vent hole 130 may provide for gas flow communication between the interface of magnets 118 and shaft 110 and the hollow interior 116 of shaft 110. Advantageously, at least one gas vent 130 in said shaft 110 may be radially aligned with a non-magnetic wedge spacer 126 as shown in FIG. 5. Additionally, wedge spacers 126 may have beveled edges 133 providing gas flow through passages 137 about each wedge spacer 126. Optionally, at least one of the non-magnetic wedge spacer 126 may have a vent passage 128 in flow communication with bevel 132 in shaft 110 and the outside of the enclosure about shaft 110 through an aligned hole 135 in rotor sleeve 114. Advantageously, rotor assembly 200 may be substantially balanced about a central longitudinal axis thereof providing a substantially smooth rotation at high rotational speeds. In aspects of the present invention not having a gas vent 130, shaft 110 may be solid.

As shown in FIGS. 1-5, gases that may evolve from the heating of adhesives in enclosed portion 125 of rotor assembly 100 may be vented by one or more gas flow through passages. In at least one of the rotor shaft 110, cylindrical sleeve 114, non-magnetic wedge spacers 126, or end caps 112 there may be a gas flow through passage providing flow communication with enclosed portion 125 and an environment outside of enclosed portion 125 of rotor assembly 100. The gas flow through passage in rotor shaft 110 may be vent hole 130. The gas flow through passage in cylindrical sleeve 114 may be vent hole 135. The gas flow through passage in non-magnetic wedge spacers 126 may be gas flow through passages 137 and/or vent passage 128. The gas flow through passages in end caps 112 may be vent holes 120. Only one or any combination of gas flow through passages 120, 128, 130, 135, and 137 or other passages that will become apparent to one skilled in the art upon this disclosure may be incorporated to into a rotor assembly to provide release of gases from a rotor assembly.

It should be understood, of course, that the foregoing relates to exemplary embodiments of the invention and that modifications may be made without departing from the spirit and scope of the invention as set forth in the following claims.

We claim:

1. A rotor assembly for an electric motor comprising:
a rotor shaft having
at least one magnet proximatean outer surface thereof;
a cylindrical sleeve positioned about said outer surface of said rotor shaft;
an end cap or stub shaft proximate each end of said cylindrical sleeve, each of said end caps or stub shafts having an outer surface adjacent to said cylindrical sleeve forming an enclosed portion of said rotor assembly; and
at least one gas flow through passage in flow communication with said enclosed portion and an environment outside of said enclosed portion of said rotor assembly.

2. The rotor assembly of claim 1 wherein each said end caps or stub shafts has at least one vent hole or channel extending from an inside face adjacent said rotor shaft to an outside face thereof.

3. The rotor assembly of claim 2 wherein each of said end caps or stub shafts are substantially balanced about a central axis and have a plurality of said vent holes or channels.

4. The rotor assembly of claim 1 wherein said rotor shaft has a hollow center opening at each axial end thereof and each said end caps or stub shafts has a central aperture axially aligned with said openings forming a central hollow portion in said rotor assembly in flow communication with the environment outside of said enclosed portion thereof.

5. The rotor assembly of claim 4 wherein each of said rotor shaft has a at least one radial vent hole therein in flow communication with said central hollow portion in said rotor assembly.

6. The rotor assembly of claim 1 wherein said rotor shaft is beveled adjacent each longitudinal end thereof, at least one of end caps or stub shafts has at least one gas flow through passage in flow communication with said bevel in said rotor shaft.

7. The rotor assembly of claim 1 wherein the rotor assembly is substantially balanced about a central longitudinal axis thereof.

8. The rotor assembly of claim 1 wherein said rotor shaft is solid.

9. End caps or stub shafts for a rotor assembly comprising:
a disk portion having an inside face, an outside face;
at least one vent hole or channel extending from said inside face to said outside face of said disk portion.

10. The end caps or stub shafts of claim 9 having a plurality of said vent holes or channels extending from an outer edge of said inside face of said disk portion radially aligned about said disk.

11. The end caps or stub shafts of claim 9 wherein each of said vent holes or channels in said disk are radially aligned about said disk portion wherein said end caps or stub shafts are balanced about a central longitudinal axis.

12. The end caps or stub shafts of claim 9 wherein said outside edge of said inside face of said disk portion is beveled.

13. The end caps or stub shafts of claim 9 having a central axial aperture therein, an inside edge of said inside face of said disk portion at said central axial aperture being beveled.

14. A rotor assembly for an electric motor comprising:
a rotor shaft comprising at least one magnet;
a rotor sleeve closely receiving said at least one magnet;
an end cap or stub shaft adhesively or mechanically held within or to each end of said rotor sleeve, each end cap or stub shaft having a central aperture closely receiving said shaft forming an enclosure about said at least one magnet; and
at least one gas vent for venting gases evolved from heating an adhesive in said enclosure to an environment outside of said enclosure.

15. The rotor assembly of claim 14 wherein said at least one gas vent comprises at least one vent hole or channel in each of said end caps or stub shafts extending from an inside face adjacent said at least one magnet to an outside face thereof.

17. The rotor assembly of claim 14 wherein
said rotor shaft has a hollow interior opening in axial ends thereof, said end caps or stub shafts have a central aperture axially aligning with said openings in said rotor shaft.

18. The rotor assembly of claim 14 wherein said at least one gas vent has a gas vent about an outer radius of said rotor shaft adjacent said end caps or stub shafts.

19. The rotor assembly of claim 14 wherein said at least one gas vent comprises:
said rotor shaft beveled on an outer surface adjacent each longitudinal end thereof; and
at least one vent passage in said rotor shaft in flow communication with said bevel in said shaft and the outside of said enclosure through an aligned hole in said rotor sleeve.

20. The rotor assembly of claim 14 wherein the rotor assembly is substantially balanced about a central longitudinal axis thereof.
